(19) United States
(12) Patent Application Publication
(10) Pub. No.: US 2007/0246785 A1
(43) Pub. Date: Oct. 25, 2007

(54) Locking device, adjustment mechanism and lithographic apparatus

(75) Inventor: Edwin Eduard Nicolaas Josephus Krijnen, Geffen (NL)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: ASML NETHERLANDS B.V., Veldhoven (NL)

(21) Appl. No.: 11/407,338

(22) Filed: Apr. 20, 2006

(51) Int. Cl. B25B 1/24

(52) U.S. Cl. 257/409; 269/266

(57) ABSTRACT

A locking device to lock a six degree of freedom positioned body is disclosed. The device has a clamping bushing to clamp against a surface of a bore extending through the body, a clamping ring to expand when subject to a compression force, and a lock actuator configured to cause the force to be applied so that the clamping ring expands against the clamping bushing so as to cause the clamping bushing to be pushed into contact against the surface. An adjustment mechanism to adjust a position of a body is also disclosed. The mechanism has an intermediate body on which the body is mounted and first and second adjustment elements to adjust a position of the intermediate body with respect to a fixed location in first and second directions, respectively, so that adjustment of the intermediate body is effected substantially in a plane defined by the directions.

### FIELD

The present invention relates to a locking device, an adjustment mechanism, a lithographic apparatus and a method for manufacturing a device.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In various applications, such as lithographic applications, adjusted mechanisms (also referred to as bodies, objects and systems) which are adjustable to various positions are to be locked or secured without losing their adjustment to the position. Conventionally, this may be achieved by clamping an axle (shaft) radially using locking bolts. In such conventional systems, the locking bolts are disposed so that they are accessible axially. When an adjustment of body is carried out for six degrees of freedom, that is x, y, z, Rx, Ry, Rz, locking of the adjusted position without losing the adjustment of the body may be problematic.

In particular, in a lithographic apparatus, various bodies, such as the illumination system and/or projection system, are adjusted in a particular position. The position is then locked. Providing an effective locking device for such bodies, in a limited space, which is accessible and which provides a required degree of accuracy may be problematic.

Further, in various applications, such as lithographic applications, adjusted mechanisms (also referred to as bodies, objects and systems) are desired to be positionally adjustable to a highly accurate degree. Conventionally, this may be carried out by shifting or rolling the body to the desired location. However, when the mass of the body is high, for example, of the order of 1200 kg, and the desired accuracy high, for example, of the order of +/−6 micrometers, conventional adjustment possibilities may be limited.

In particular, in a lithographic apparatus, it may be desirable to adjust an illumination system platform. It may be desirable to adjust and lock the illumination system platform at a predetermined position. Providing an effective adjustment mechanism for the illumination system platform in a limited space, which is accessible and which may be adjusted to the desired degree of accuracy may be problematic.

### SUMMARY

It is desirable to address one or more problems encountered with conventional locking devices. In particular, it is desirable, for example, to lock a body having six degrees of freedom, for example, to lock an illumination system or a projection system.

It is desirable to address one or more problems encountered with conventional adjustment mechanisms. In particular, it is desirable, for example, to adjust a body having a mass to a desired high degree of accuracy, for example, to adjust an illumination system platform or other body.

According to an aspect of the invention, there is provided a locking device to lock a six degree of freedom positioned body, the locking device comprising:
a clamping bushing, disposed around an axis, to clamp against an inner surface of a substantially cylindrical bore extending through the body;
a clamping ring, disposed around the axis, arranged to expand radially when subject to a compression force exerted substantially along the axis; and
a lock actuator configured to cause the compression force to be applied so that the clamping ring expands radially against the clamping bushing so as to cause the clamping bushing to be pushed into contact against the inner surface such that the body is in a locked position by virtue of the force exerted by the clamping bushing against the inner surface.

According to an aspect of the invention, there is provided a body comprising a bore extending through the body, the body being positionable with at least one degree of freedom and being lockable with the above locking device, insertable into the bore.

According to an aspect of the invention, there is provided a lithographic apparatus, comprising:
an illumination system configured to condition a radiation beam, a projection system configured to project a patterned radiation beam onto a target portion of a substrate, or both; and
a locking device to lock the illumination system, the projection system, or both, in a fixed position, the locking device comprising:
   a clamping bushing, disposed around an axis, to clamp against an inner surface of a substantially cylindrical bore extending through a portion of the illumination system, the projection system, or both,
   a clamping ring, disposed around the axis, arranged to expand radially when subject to a compression force exerted substantially along the axis, and
   a lock actuator configured to cause the compression force to be applied so that the clamping ring expands radially against the clamping bushing so as to cause the clamping bushing to be pushed into contact against the inner surface such that the illumination system, the projection system, or both is in a locked position by virtue of the force exerted by the clamping bushing against the inner surface.

According to an aspect of the invention, there is provided a method of locking a six degree of freedom positioned body, the method comprising causing a compression force to be applied along an axis around which a clamping ring is disposed, the compression force causing the clamping ring to expand in a radial direction against a clamping bushing, disposed around the axis, such that the clamping bushing is pushed into contact against an inner surface of a substantially cylindrical bore extending through the body to form a locked state in which the body is in a locked position by virtue of the force exerted by the clamping bushing against the inner surface of the bore.

According to an aspect of the invention, there is provided an adjustment mechanism to adjust a position of a body having a mass, the adjustment mechanism comprising:
an intermediate body on which the body is mounted, the intermediate body comprising a first portion extending in a first direction and a second portion extending in a second direction, wherein the first and second directions define a plane; and
first and second adjustment elements of the intermediate body to adjust a position of the intermediate body with respect to a fixed location in the first and second directions, respectively, so that adjustment of the intermediate body is effected substantially in the plane by providing the intermediate body with degrees of freedom in the first and second directions.

According to an aspect of the invention, there is provided a locking device for insertion in the above adjustment mechanism.

According to an aspect of the invention, there is provided a lithographic apparatus, comprising:
an illumination system configured to condition a radiation beam, a projection system configured to project a patterned radiation beam onto a target portion of a substrate, or both; and
an adjustment mechanism to adjust a position of a part of the lithographic apparatus, such as the illumination system, the projection system, or both, the adjustment mechanism comprising:
an intermediate body on which the part is mounted, the intermediate body comprising a first portion extending in a first direction and a second portion extending in a second direction, wherein the first and second directions define a plane; and
first and second adjustment elements of the intermediate body to adjust a position of the intermediate body with respect to a fixed location in the first and second directions, respectively, so that adjustment of the intermediate body is effected substantially in the plane by providing the intermediate body with degrees of freedom in the first and second directions.

According to an aspect of the invention, there is provided a method of adjusting a position of a body having a mass, the method comprising:
providing an intermediate body on which the body is mounted, the intermediate body comprising a first portion extending in a first direction and a second portion extending in a second direction, wherein the first and second directions define a plane; and
providing on the intermediate body first and second adjustment elements to adjust the position of the intermediate body with respect to a fixed location in the first and second directions, respectively, so that adjustment of the intermediate body is effected in the plane by providing the intermediate body with degrees of freedom in the first and second directions.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a cross sectional view of a locking device according to an embodiment of the invention;

FIG. 3 depicts a three dimensional view of a locking device according to an embodiment of the invention;

FIG. 4 depicts a top view of a locking device according to an embodiment of the invention, wherein the cross sectional view of FIG. 2 is taken along SA-SA;

FIG. 5 depicts a three dimensional view of a body to be locked according to an embodiment of the invention;

FIG. 6 depicts an adjustment principle of the body to be locked depicted in FIG. 5, and

FIG. 7 depicts a schematic view of the adjustment mechanics of an object to be locked, in particular, an illumination system.

### DETAILED DESCRIPTION

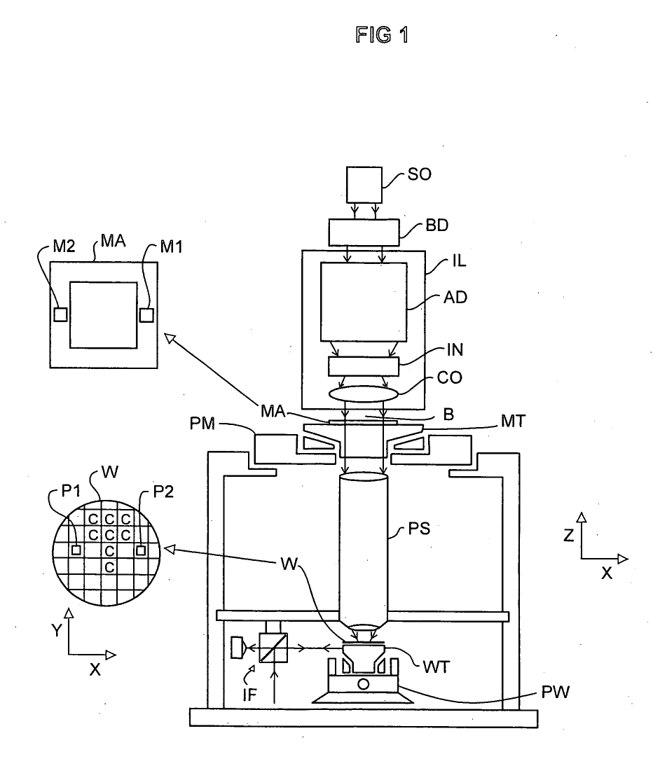

FIG. 1 schematically depicts a lithographic apparatus according to an embodiment of the invention. The apparatus comprises:

an illumination system (illuminator) IL configured to condition a radiation beam B (e.g. UV radiation or EUV radiation);

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more support structures). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

FIG. 2 depicts a cross sectional view of a locking device according to an embodiment of the invention. In particular, FIG. 2 shows a locking device 1 configured to lock a six degree of freedom positioned body 2. The body may be, for example, an illuminator IL and/or a projection system PS of a lithographic apparatus. Alternatively, the body may be an intermediate body on which a further body, for example, the illuminator IL or the projection system PS is mounted. The locking device 1 may comprise an axis 4 around which a cylindrically or spherically shaped clamping bushing 6 is disposed. In an embodiment, the clamping bushing has a surface of a portion of a sphere. The clamping bushing is arranged to clamp against an inner surface 8 of a substantially cylindrical bore 10 extending through the body 2. The locking device may further comprise one or more clamping rings 12 disposed around the axis 4. The one or more clamping rings may be arranged to expand radially when subject to a compression force exerted along the axis 4. The one or more clamping rings 12 may be RINGSPANN™ clamping rings. They may expand radially while they are compressed axially. The locking device 1 may further comprise a lock actuator 14 to cause the compression force to be applied to the one or more clamping rings 12 so as to cause the one or more clamping rings to expand in the radial direction against the clamping bushing 6. This radial expansion would cause the clamping bushing 6 to be pushed into contact against the inner surface 8 to form a locked state in which the body 2 is in a locked position by virtue of the force exerted by the clamping bushing 6 against the inner surface 8 of bore 10.

In particular, the body 2 which is adjusted at a certain position is fixed for six degrees of freedom. The lock actuator 14 may comprise a bolt. However, alternatively, another element may be used which may deliver the necessary force. Via a pressing ring 16, which makes x and y displacements possible, the clamping force is directed towards a distance ring 18 and a bushing 20. The distance ring 18 may be arranged to press one or more spring elements 22, for example, a set of springs. The one or more spring elements 22 limit the force onto a further pressing ring 24. The further pressing ring 24 is arranged to exert a compression force, i.e. press, on to the one or more clamping rings 12. As mentioned, the one or more clamping rings 12 may expand radially while they are compressed axially. The axial expansion is directed towards the clamping bushing 6 by the one or more clamping rings 12. The clamping bushing 6 may secure the adjusted body without displacement of the adjusted body. In this way an accurate adjustment is achieved. For example, the adjusted body is locked in its adjusted position with an accuracy of +/−1 micrometer. The locked state is maintained only by radial forces counteracting each other in the cylindrical bore.

In particular, the locking device 1 may be dimensioned so that in an unlocked state it is movable with six degrees of freedom in the bore 10. In this way, regardless of the orientation of the locking device 1 in the bore 10, the locked state is achieved by actuating the lock actuator 14. As mentioned, in the locked state the body 2 is locked by the locking device 1 in a position in the bore 10, so that the body 2 is held in a stationary position by the locking device 1. A further bushing 26 together with the bushing 20 may be provided to fix the locking device 1 via the clamping bushing 6 to a base 28. The base may be a fixed base. In particular, the locking device 1 may be fixed at a location 28 and the body 2 is positionable with respect to the locking device 1 with six degrees of freedom.

In an embodiment, the lock actuator 14 may be disposed at an accessible location on the locking device. In this way, the locking of the body may be achieved more readily and with less time overhead. In an embodiment, this may be achieved by disposing the locking actuating element 14 on an upper portion 30 of the locking device 1. As mentioned above, the locking device 1 may comprise a first pressing ring 16 and a distance ring 18 disposed around the axis 4, respectively. The first pressing ring 16 may be arranged to transfer the compression from the lock actuator 14 to the distance ring 18. In an embodiment, the locking device is spring loaded. In this way, the force exerted by the lock actuator 14 may be limited. This may be achieved by providing the one or more spring elements 22 wherein the one or more spring elements 22 are arranged to limit the force exerted on to the one or more clamping rings 12. In particular, the locking device 1 may comprise a second pressing ring 24 disposed between the one or more spring elements 22 and the one or more clamping rings 12, to transfer a limited force from the one or more spring elements 22 to the one or more clamping rings 12.

The locking device 1 may have several applications. Further the body may be a body or an intermediate body on which a body is mounted. In an embodiment, a lithographic apparatus, such as that shown in FIG. 1, may comprise an illumination system IL configured to condition a radiation beam and/or a projection system PS configured to project a patterned radiation beam onto a target portion of a substrate W. The apparatus may further comprise an intermediate body 2 to support the illumination system IL and/or projection system PS and a locking device 1 according to an embodiment of the invention, wherein the locking device is arranged to lock the illumination system and/or the projection system in a fixed position.

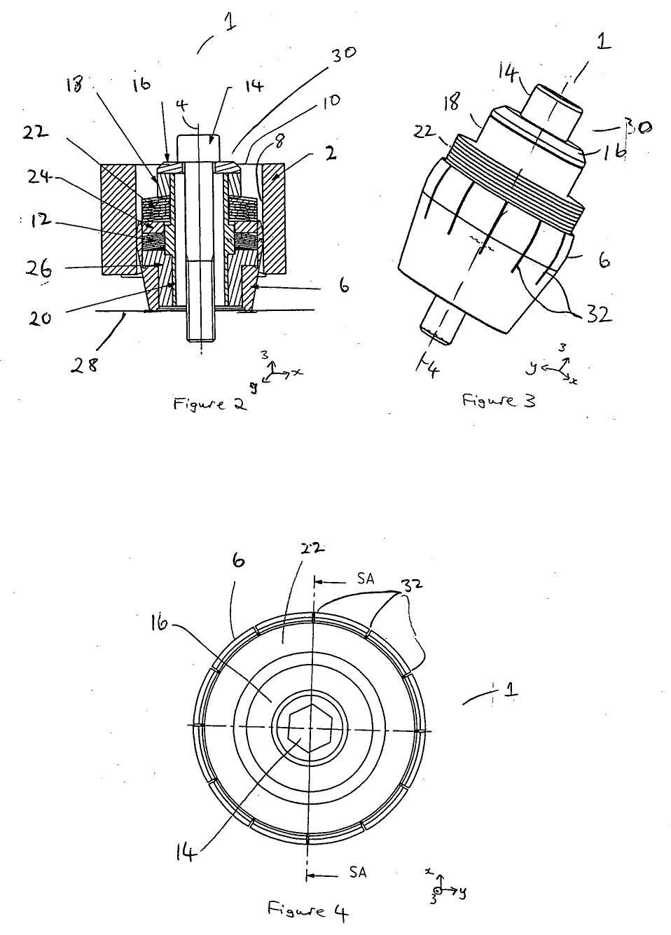

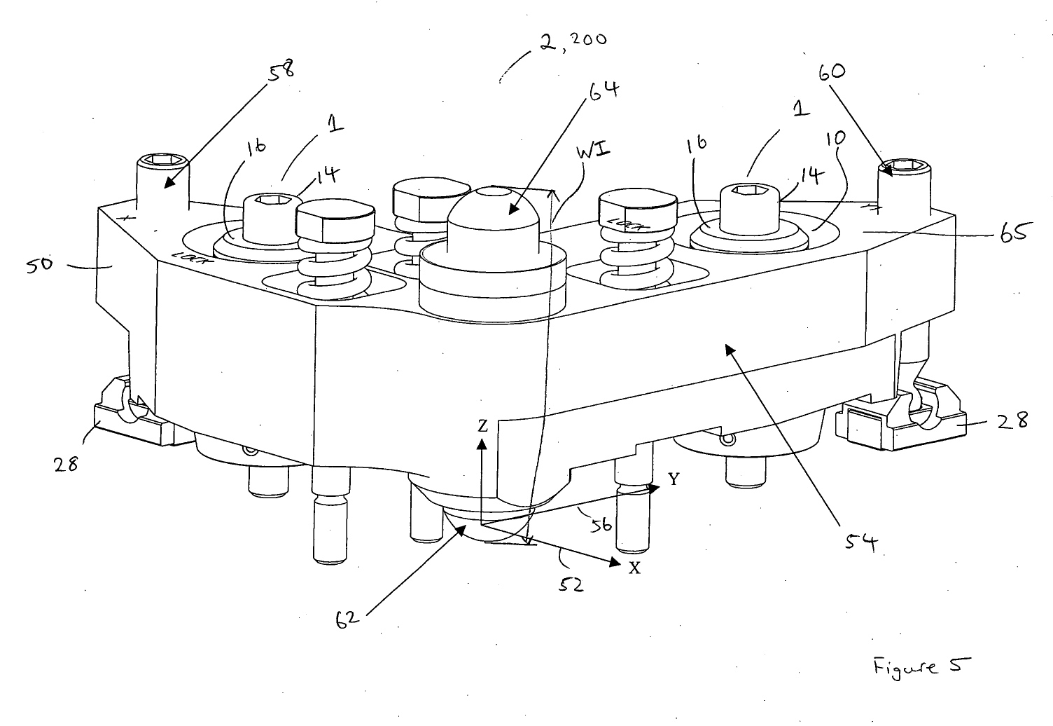

FIG. 3 depicts a three dimensional view of a locking device according to an embodiment of the invention. In particular, FIG. 3 depicts a three dimensional view of the locking device depicted in FIG. 2. It may be seen that in an embodiment of the invention, the clamping bushing 6 comprises one or more slits 32 disposed around the axis 4 to allow the clamping bushing 6 to expand to contact the inner surface 8 of the bore 10 when subject to a force exerted by the one or more clamping rings 12.

FIG. 4 depicts a top view of a locking device according to an embodiment of the invention, wherein the cross sectional view of FIG. 2 is taken along SA-SA. In particular, FIG. 4 shows that the bolt may be a hexagonal bolt. The slits 32 may be disposed with a certain distance between adjacent slits. In this way, the clamping bushing 6 may be allowed to expand equally around a periphery of the clamping bushing 6 to exert a substantially equal force against the inner surface 8 of the bore 10 around the periphery of the clamping bushing 6.

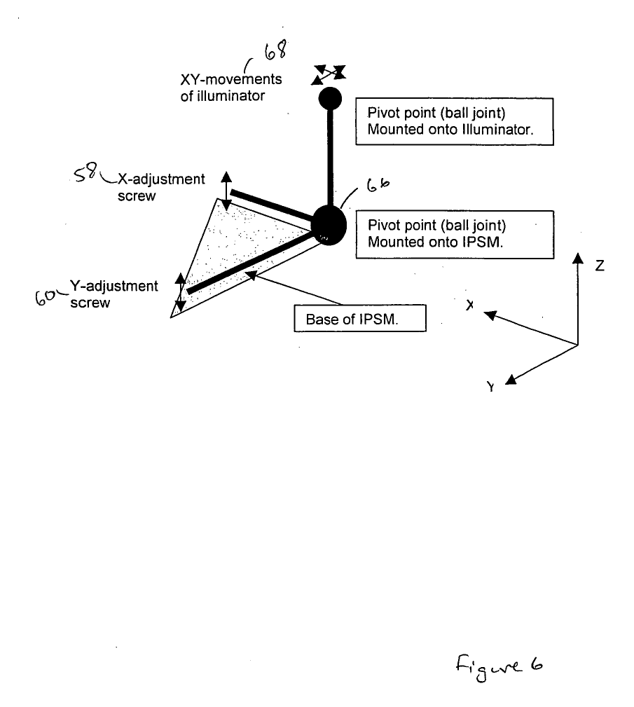

FIG. 5 depicts a three dimensional view of a body to be locked according to an embodiment of the invention. In particular, FIG. 5 depicts an intermediate body 2 to be locked with the locking device 1 depicted in FIGS. 2 to 4. The intermediate body 2 may comprise a bore 10 extending through the body 2. The body 2 may be positionable with at least one degree of freedom. Further, the body 2 may be lockable with the locking device 1. In an embodiment, the body 2 may be lockable with a plurality of locking devices 1. The locking device 1 may be inserted into the bore 10. In an unlocked state the locking device 1 may be freely insertable in the bore 10. It may have one or more, up to six degrees of freedom. To lock the body 2, the bolt 14 is actuated. The bolt 14 is readily accessible, since in an embodiment it may be located on an upper portion of the locking device. The intermediate body 2 is fixable to a base 28. It may support a further body or object, such as an illuminator IL, a projection system PS, and/or other component of a lithographic apparatus. In an embodiment, the body may be tiltable. In this way, the intermediate body and the body it may support may be readily adjusted.

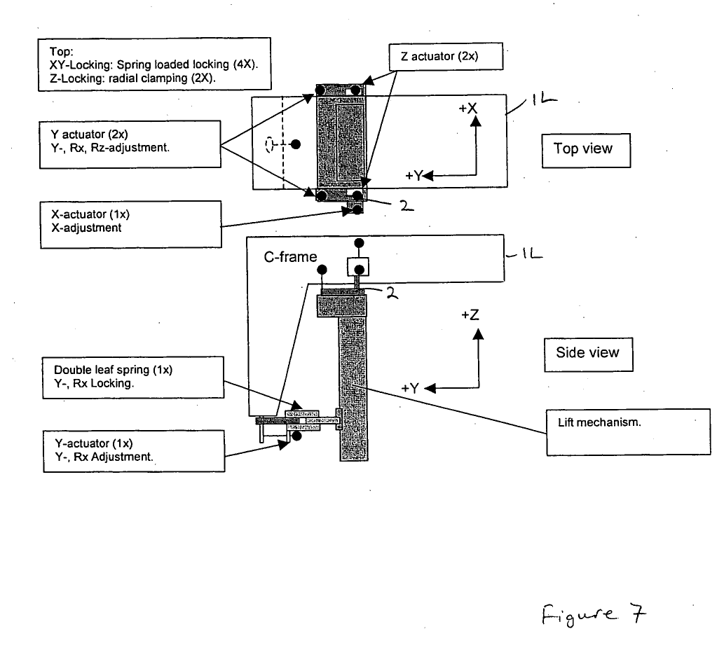

With reference to FIG. 5, an adjustment mechanism 200 is provided to adjust a position of a body (refer to FIG. 7) having a mass. In particular, the body may have a high mass. The adjustment mechanism may comprise an intermediate body 2 on which the body is mounted. The intermediate body 2 may comprise a first portion 50 extending in a first (x) direction 52 and a second (y) portion 54 extending in a second direction 56. The first and second directions 52, 56 may define a plane (xy). The intermediate body 2 may further comprise first and second adjustment elements 58, 60 to adjust the position of the intermediate body 2 with respect to a fixed location in the first and second directions 52, 56, respectively, so that adjustment of the intermediate body 2 is effected in the plane (xy) by tilting the intermediate body 2 in the first and second directions 52, 56. In the example, shown in FIG. 5, the body to be supported is an illuminator IL and the fixed location is a base of an illuminator/position service module (IPSM, shown in FIG. 6). In this way, the mass body can be readily adjusted by adjusting the adjustment elements in the plane (xy). In an embodiment, the first and second portions 50, 54 may be cojoined to pivot at a single pivot point. By allowing the intermediate body to pivot, the body may be adjusted without encountering a large degree of friction, which may hinder adjustment of the body. In an embodiment, the intermediate body 2 may further comprise a first ball joint 62 to couple the intermediate body 2 to the fixed location (the base of the IPSM shown in FIG. 6). In this way, the intermediate body may be coupled to the fixed world while minimizing friction. Further, the intermediate body 2 may further comprise a second ball joint 64 to couple the intermediate body to the body (e.g., the illuminator). In this way, the intermediate body may be coupled to the body while minimizing friction. In particular, the first ball joint 62 may be disposed at the pivot point 66, shown in FIG. 6. In the embodiment shown in FIGS. 5 to 7, the first and second adjustment elements 58, 60 may comprise first and second adjustment screws, respectively. In this way, an adjustment may be readily carried out by turning the screws. In particular, the adjustment elements are accessible. This may be achieved by disposing the adjustment elements 58, 60 on an upper facing surface 65 of the intermediate body 2. In this way, access to the adjustment elements is readily achieved. Further, the intermediate body 2 may comprise a bore 10 into which a locking device 1 may be inserted, to lock the intermediate body 2 at an adjusted position. The locking device 1 may be a locking device as described with reference to FIGS. 2 to 4.

Depending on the ratio of the width WI of the intermediate body at the center with respect to the distance from the adjusting elements 58, 60 to the center, the amount of adjustment provided will vary. In the example shown in FIG. 5, the width WI is approximately half the distance from the adjusting elements 58, 60 to the center. The width WI being approximately 100 mm and the distance from the adjusting elements 58, 60 to the center 64 being approximately 200 mm. Thus, by activating the first adjustment element 58 by 1 mm results in a displacement of 0.5 mm. In the xy plane example, the z movement (parasitic) is relatively small for small xy movement (in fact the movement is circular). Thus, the adjustment may result in a substantially linear displacement of the intermediate body 2. As mentioned, parasitic displacement in a direction out of the plane (z) is substantially suppressed.

As mentioned, a typical distance of the first or second adjustment element 58, 60 from the pivot point 66 is around 200 mm. A typical diameter of the ball of the ball joints 62, 64 may be 30 mm. The first and second adjustment elements 58, 60 may be equidistant from the pivot point 66. In an embodiment, a distance between the first and second adjustment elements and the pivot point is approximately 10-15 times the radius of the ball joint. In this way, leverage is obtained while maintaining a linear displacement of the body.

Further, a locking device for insertion in an adjustment mechanism may be provided. In an embodiment, the locking device shown in FIGS. 2 to 4 may be provided in the intermediate body 2. An alternative or additional locking device may be provided. The adjustment mechanism according to an embodiment of the invention may have many applications. In an embodiment, a lithographic apparatus is provided, comprising an illumination system configured to condition a radiation beam and/or a projection system configured to project the patterned radiation beam onto a target portion of a substrate, the lithographic apparatus further comprising an adjustment mechanism according to an embodiment of the invention.

FIG. 6 depicts an adjustment principle of the body to be locked depicted in FIG. 5 using x, y, z coordinates and an illuminator as the body. In particular, in an embodiment, the xy adjustment may be realized by turning of the intermediate body. The principle of the adjustment is now further explained. Turning of the x or y adjustment screws results in an x or y movement 68 of the illuminator. The intermediate body 2 turns around the pivot point 66 which results in a substantially linear displacement of the illuminator IL. There should be little parasitic z displacement. As seen in FIG. 5, an advantage of an embodiment of the present invention is that the adjustment screws are readily accessible, for example, from above.

FIG. 7 depicts a schematic view of the adjustment mechanics of an object to be locked, in particular, an illuminator. In particular, FIG. 7 shows a schematic view of the total adjustment mechanics of the illuminator. In the upper portion of FIG. 7 a top view is provided. In the lower portion of FIG. 7 a side view is provided. It is seen that the adjustment mechanism according to an embodiment of the invention and as depicted in FIG. 5, is utilized twice.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A locking device to lock a six degree of freedom positioned body, the locking device comprising:
a clamping bushing, disposed around an axis, to clamp against an inner surface of a substantially cylindrical bore extending through the body;
a clamping ring, disposed around the axis, arranged to expand radially when subject to a compression force exerted substantially along the axis; and
a lock actuator configured to cause the compression force to be applied so that the clamping ring expands radially against the clamping bushing so as to cause the clamping bushing to be pushed into contact against the inner surface such that the body is in a locked position by virtue of the force exerted by the clamping bushing against the inner surface.

2. The device of claim 1, wherein the locking device is dimensioned so that in an unlocked state the bore or the locking device is movable with six degrees of freedom relative to the other of the bore or the locking device.

3. The device of claim 2, wherein regardless of the orientation of the locking device in the bore, the locked position is achieved by actuating the lock actuator.

4. The device of claim 1, wherein in the locked position the body is locked by the locking device in a position in the bore, so that the body is held stationary by the locking device.

5. The device of claim 1, wherein the locking device is fixed at a location and the body is positionable with respect to the locking device with six degrees of freedom.

6. The device of claim 1, wherein the lock actuator is disposed at an accessible location on the locking device.

7. The device of claim 1, wherein the lock actuator is a bolt disposed on an upper portion of the locking device.

8. The device of claim 1, further comprising a first pressing ring and a distance ring disposed around the axis, respectively, the first pressing ring arranged to transfer the compression force from the lock actuator to the distance ring.

9. The device of claim 1, wherein the locking device is spring loaded.

10. The device of claim 9, further comprising a spring element arranged to limit the force exerted onto the clamping ring.

11. The device of claim 10, further comprising a second pressing ring, disposed between the spring element and the clamping ring, to transfer a limited force from the spring element to the clamping ring.

12. The device of claim 1, wherein the clamping bushing comprises a slit to allow the clamping bushing to expand to contact the inner surface of the bore when subject to a force exerted by the clamping ring.

13. The device of claim 12, wherein a plurality of slits are provided and are disposed around the axis at a certain distance between adjacent slits.

14. The device of claim 1, further comprising the body.

15. The device of claim 1, wherein the clamping bushing has a spherical surface.

16. A body comprising a bore extending through the body, the body being positionable with at least one degree of freedom and being lockable with a locking device, insertable into the bore, according to claim 1.

17. The body of claim 16, wherein the body is tiltable.

18. The body of claim 16, wherein the body is an intermediate body adapted to support an object.

19. The body of claim 18, wherein the object is a component of a lithographic apparatus, such as a projection system or an illumination system.

20. A lithographic apparatus, comprising:
an illumination system configured to condition a radiation beam, a projection system configured to project a patterned radiation beam onto a target portion of a substrate, or both; and
a locking device to lock the illumination system, the projection system, or both, in a fixed position, the locking device comprising:
a clamping bushing, disposed around an axis, to clamp against an inner surface of a substantially cylindrical bore extending through a portion of the illumination system, the projection system, or both,
a clamping ring, disposed around the axis, arranged to expand radially when subject to a compression force exerted substantially along the axis, and
a lock actuator configured to cause the compression force to be applied so that the clamping ring expands radially against the clamping bushing so as to cause the clamping bushing to be pushed into contact against the inner surface such that the illumination system, the projection system, or both is in a locked position by virtue of the force exerted by the clamping bushing against the inner surface.

21. The apparatus of claim 20, wherein the clamping bushing has a spherical surface.

22. A method of locking a six degree of freedom positioned body, the method comprising causing a compression force to be applied along an axis around which a clamping ring is disposed, the compression force causing the clamping ring to expand in a radial direction against a clamping bushing, disposed around the axis, such that the clamping bushing is pushed into contact against an inner surface of a substantially cylindrical bore extending through the body to form a locked state in which the body is in a locked position by virtue of the force exerted by the clamping bushing against the inner surface of the bore.

23. The method of claim 22, wherein the clamping bushing has a spherical surface.

24. An adjustment mechanism to adjust a position of a body having a mass, the adjustment mechanism comprising:
an intermediate body on which the body is mounted, the intermediate body comprising a first portion extending in a first direction and a second portion extending in a second direction, wherein the first and second directions define a plane; and
first and second adjustment elements of the intermediate body to adjust a position of the intermediate body with respect to a fixed location in the first and second directions, respectively, so that adjustment of the intermediate body is effected substantially in the plane by providing the intermediate body with degrees of freedom in the first and second directions.

25. The mechanism of claim 24, wherein adjustment of the intermediate body is effected in the plane by tilting the intermediate body.

26. The mechanism of claim 24, wherein the first and second portions are cojoined to pivot at a single pivot point.

27. The mechanism of claim 26, wherein activating the first or second adjustment elements, respectively, results in a movement of the intermediate body in the first or second directions, respectively, relative to the pivot point, which results in a substantially linear displacement of the intermediate body.

28. The mechanism of claim 27, wherein parasitic displacement in a direction out of the plane is suppressed.

29. The mechanism of claim 24, wherein the intermediate body further comprises a first ball joint to couple the intermediate body to the fixed location.

30. The mechanism of claim 29, wherein the intermediate body further comprises a second ball joint to couple the intermediate body to the body and wherein the first and second ball joints, respectively, are disposed at a pivot point.

31. The mechanism of claim 24, wherein the intermediate body further comprises a second ball joint to couple the intermediate body to the body.

32. The mechanism of claim 24, wherein a distance between the first and second adjustment elements and a pivot point is approximately 10-15 times the radius of a ball joint to couple the intermediate body to the fixed location, of a ball joint to couple the intermediate body to the body, or both.

33. The mechanism of claim 24, wherein the first and second adjustment elements comprise first and second adjustment screws, respectively.

34. The mechanism of claim 24, wherein the intermediate body comprises a bore into which a locking device may be inserted to lock the intermediate body at an adjusted position, the locking device comprising:
a clamping bushing, disposed around an axis, to clamp against an inner surface of a substantially cylindrical bore extending through the intermediate body,
a clamping ring, disposed around the axis, arranged to expand radially when subject to a compression force exerted substantially along the axis, and
a lock actuator configured to cause the compression force to be applied so that the clamping ring expands radially against the clamping bushing so as to cause the clamping bushing to be pushed into contact against the inner surface such that the intermediate body is in a locked position by virtue of the force exerted by the clamping bushing against the inner surface.

35. The mechanism of claim 24, wherein the adjustment elements are accessible.

36. The mechanism of claim 24, wherein the adjustment elements are disposed on an upper facing surface of the intermediate body.

37. A locking device for insertion in an adjustment mechanism according to claim 24.

38. A lithographic apparatus, comprising:
an illumination system configured to condition a radiation beam, a projection system configured to project a patterned radiation beam onto a target portion of a substrate, or both; and
an adjustment mechanism to adjust a position of a part of the lithographic apparatus, such as the illumination system, the projection system, or both, the adjustment mechanism comprising:
an intermediate body on which the part is mounted, the intermediate body comprising a first portion extending in a first direction and a second portion extending in a second direction, wherein the first and second directions define a plane; and
first and second adjustment elements of the intermediate body to adjust a position of the intermediate body with respect to a fixed location in the first and second directions, respectively, so that adjustment of the intermediate body is effected substantially in the plane by providing the intermediate body with degrees of freedom in the first and second directions.

39. A method of adjusting a position of a body having a mass, the method comprising:
providing an intermediate body on which the body is mounted, the intermediate body comprising a first portion extending in a first direction and a second portion extending in a second direction, wherein the first and second directions define a plane; and
providing on the intermediate body first and second adjustment elements to adjust the position of the intermediate body with respect to a fixed location in the first and second directions, respectively, so that adjustment of the intermediate body is effected in the plane by providing the intermediate body with degrees of freedom in the first and second directions.
